(19) United States
(12) Patent Application Publication
(10) Pub. No.: US 2021/0073443 A1
(43) Pub. Date: Mar. 11, 2021

(54) FAST AND DETERMINISTIC ALGORITHM FOR CONSENSUS SET MAXIMIZATION

(71) Applicant: SHANGHAITECH UNIVERSITY, Shanghai (CN)

(72) Inventors: Zhiru Shi, Shanghai (CN); Ziran Xing, Shanghai (CN)

(21) Appl. No.: 17/099,445

(22) Filed: Nov. 16, 2020

Related U.S. Application Data
(63) Continuation of application No. PCT/CN2018/086803, filed on May 15, 2018.

(51) Int. Cl. G06F 30/20; G06F 17/16

(52) U.S. Cl. CPC G06F 30/20; G06F 2111/10; G06F 17/16

(57) ABSTRACT

A method for approximately solving a consensus set maximization (“CSM”) problem for a dataset is disclosed. The method comprises relaxing a maximum fitting residual constraint in the CSM problem to an average error bounded constraint; defining a plurality of decision problems related to the relaxed CSM problem; solving each decision problem by defining an optimization problem; and selecting a consensus size for the CSM problem based on solutions to the decision problems.

### CROSS-REFERENCE TO RELATED APPLICATION

This application is a continuation application of International Patent Application No. PCT/CN2018/086803, filed on May 15, 2018. The above-referenced application is incorporated herein by its entirety.

### TECHNICAL FIELD

The present invention relates to intelligent machine and computer vision, and more particularly, to a method for extracting the maximum consensus set from a large-scale dataset.

### BACKGROUND

With the current booming applications of virtual reality (VR), augmented reality (AR), and robotics, efficiently extracting the maximum consensus set among large-scale corrupted data has become a critical challenge. However, existing methods typically focus on optimization and are rarely concerned about the running time.

### SUMMARY

To address the issues in the prior art, embodiments of the present disclosure provide a method for extracting the maximum consensus set from a large-scale dataset containing corrupted data.

In one aspect, a method for approximately solving a consensus set maximization (“CSM”) problem for a dataset is provided, the method comprises relaxing a maximum fitting residual constraint in the CSM problem to an average error bounded constraint; defining a plurality of decision problems related to the relaxed CSM problem; solving each decision problem by defining an optimization problem; and selecting a consensus size for the CSM problem based on solutions to the decision problems.

In some embodiments, the CSM problem comprises determining a maximum size of a consensus set within the dataset supporting a common model having a plurality of model parameters (θ).

In some embodiments, the maximum fitting residual constraint comprises a model fitting residual of each item in the dataset is not larger than an inlier threshold ϵ.

In some embodiments, the average error bounded constraint comprises an average fitting error in the consensus set is not larger than an inlier threshold ϵ.

In some embodiments, each of the decision problems comprises determining an indicator variable (u) so that the average fitting error is no larger than the inlier threshold E times a size of the consensus set (k).

In some embodiments, solving each of the decision problems comprises determining an indicator variable (u) so that an optimal value to minimize the L₁-norm of a robust residual function (∥P∥₁) is no larger than the inlier threshold E times the size of the consensus set (k).

In some embodiments, the method further comprises selecting the maximum value of the sizes of the consensus set (k) of the decision problems as the consensus size for the CSM problem.

In some embodiments, the method is configured for hyper-plane estimation, and the common model is defined by a model function

$$y = {θ}^{T} \cdot ( \begin{matrix}x \\ 1\end{matrix} ) ,$$

where x∈ [symbol] ^{m}, θ∈ [symbol] ^{m+1}, y∈ [symbol] , and the residual metric is

$$ρ = \vert {\tilde{θ}}^{T} . ( \begin{matrix}{x}_{i} \\ 1\end{matrix} ) - {y}_{i} \vert .$$

In some embodiments, the method is configured for homography matrix estimation, and the common model is defined by a model function

$$λ ( \begin{matrix}y \\ 1\end{matrix} ) = θ \cdot ( \begin{matrix}x \\ 1\end{matrix} ) ,$$

where the location of a point in a reference view is defined as

$$x = ( \begin{matrix}u \\ v\end{matrix} ) ,$$

the location of a corresponding point in a moving view is defined as

$$y = ( \begin{matrix}{u}^{′} \\ {v}^{′}\end{matrix} ) , λ ∈ ℝ and θ = ( \begin{matrix}{θ}_{11} & {θ}_{12} & {θ}_{13} \\ {θ}_{21} & {θ}_{22} & {θ}_{23} \\ {θ}_{31} & {θ}_{32} & {θ}_{33}\end{matrix} ) .$$

In some embodiments, the dataset comprises a VGG (Visual Geometry Group) dataset.

In another aspect, a non-transitory computer-readable medium having stored thereon computer-executable instructions is provided, said computer-executable instructions comprising a method for approximately solving a consensus set maximization (“CSM”) problem for a dataset, the method comprises relaxing a maximum fitting residual constraint in the CSM problem to an average error bounded constraint; defining a plurality of decision problems related to the relaxed CSM problem; solving each decision problem by defining an optimization problem; and selecting a consensus size for the CSM problem based on solutions to the decision problems.

### BRIEF DESCRIPTION OF THE DRAWINGS

To better illustrate the technical features of the embodiments of the present disclosure, various embodiments of the present invention will be briefly described in conjunction with the accompanying drawings.

FIG. 1 is an exemplary schematic diagram showing 100 times repeated independent trails on hyper-plane regression where the outliers are distributed as U (0, 10), according to various embodiments of the present disclosure.

FIG. 2 is an exemplary schematic diagram showing 100 times repeated independent trails on hyper-plane regression where the outliers are distributed as U (0,100), according to various embodiments of the present disclosure.

FIGS. 3A, 3B, 3C, 3D, 3E, 3F, 3G, and 3H are exemplary schematic diagrams for example results of the method on estimating homography matrix on VGG dataset, where red and green lines mean outliers and inliers respectively, according to various embodiments of the present disclosure.

FIG. 4 is an exemplary flowchart for a method of approximately solving a consensus set maximization (“CSM”) problem for a dataset, according to various embodiments of the present disclosure.

### DETAIL DESCRIPTION OF THE EMBODIMENTS

Inlier and outlier detection is one of the major challenges for intelligent machine computer vision. The number of outliers has a significant impact on the running time and solvability. Consensus set maximization (CSM) aims to maximize the number of inliers for a problem to overcome the outlier issue and provide robust estimation, improving the quality of AR, VR, or other similar visual rendering effects.

CSM is a fundamental criterion for robust model fitting problems. In general, the consensus set represents a group of data that support a common model. The CSM problem must be solved for most applications that require performing robust model fitting. One representative example is homography matrix estimation, which is a very common component of vision-based localization and is widely used in robotics navigation and augmented reality (AR). For these real-time applications, there is still no algorithm that can deterministically produce an accurate estimation from large-scale and highly corrupted data within a limited amount of running time.

The most common approach to solve CSM in existing technologies is to perform a hypothesize-and-verify paradigm. RANSAC (Random Sample Consensus) is a classical method within this framework. Its main operation is to hypothesize model parameters by fitting randomly selected minimal subsets of the data and verify these parameters by counting the number of data items that are satisfied by this model. After repeating this process many times, RANSAC will return the model that is supported by the largest consensus set. The most significant feature of RANSAC is that the probability of its solution being optimal is dependent on the number of iterations, as the probability of obtaining the optimal solution increases with an increasing number of iterations. However, the running time of RANSAC tends to be long because the quality of its solution cannot be guaranteed with a limited number of iterations.

Several methods based on RANSAC have been proposed to reduce the running time. PROSAC can reduce the number of iterations by utilizing the prior knowledge of the order of the probabilities that each datum is an inlier. However, PROSAC performs similarly to RANSAC when these priors are incorrect or difficult to estimate.

Another paradigm in existing technologies employs optimization algorithms, such as Norm-optimizers and M-estimators. Iteratively Reweighted Least Squares (IRLS) is a widely-used algorithm for statistical cost optimization. One significant advantage of IRLS is its low computational complexity, as the weighted least squares (LSQ) can be solved efficiently and the robust distance functions are typically differentiable. However, the quality of an IRLS result is dependent on the selection of the robust distance function. For computer vision applications, even after selecting a good distance function, it is still difficult to satisfy efficiency and optimality simultaneously. Other algorithms focus on the optimality of solutions. These existing methods inevitably use an exhaustive search to achieve the global optimum, which is not suitable for large-scale input problems because the computational complexity is exponential. Most recently, a deterministic and locally convergent algorithm was established for iteratively solving linear programming problems. However, this algorithm relies on a good initialization and requires many iterations.

In accordance with embodiment of the present invention, a fast and deterministic algorithm to solve the CSM problem approximately is provided. First, a novel formulation that transforms the original problem into a sequence of decision problems (DPs) is disclosed. Second, an efficient algorithm to assess the feasibility of these DPs is disclosed. Comprehensive experiments on linear hyper-plane regression and non-linear homography matrix estimation show that the disclosed method is fully deterministic and can effectively process large-scale and highly corrupted data without any special initialization. Under a pure MATLAB implementation and a laptop CPU, the disclosed method can successfully determine the maximum consensus set from 1,000 input data points (with 70% of them being outliers) at 30 Hz.

In accordance with embodiment of the present invention, the general form of the original CSM problem is first defined (see equation (1) below). Then, a relaxed problem is introduced (see equation (3) below). This relaxed problem can be equivalently reduced to a sequence of decision problems (DPs) (see equation (4) below). Finally, solving these DPs is equivalent to solving equation (5), and a new efficient algorithm is disclosed to approximate equation (5). In summary, the consensus maximization is first reformulated and relaxed as a sequence of DPs. Second, an efficient algorithm is disclosed to determine the feasibility of these DPs. The disclosed algorithm can process large-scale and highly corrupted (outlier ratio of up to 80%) data in real-time without any special initialization.

### Problem Definition

In some embodiments, the consensus set maximization problem is denoted as follows: given N pairs of measurements (xᵢ, yᵢ), i∈{1, 2, . . . , N} under the system y=f(x, θ), x∈ [symbol] ^{m}, y∈ [symbol] ⁿ, the unknown parameters θ that can be supported by the largest consensus set is estimated, i.e., the model fitting residual of each item in I is not larger than inlier threshold ϵ. Formally, the problem is defined as:

$$\begin{matrix}{max}_{θ} & \vert I \vert \\ s . t . & I = \{ ( {x}_{i} , {y}_{i} ) \vert ρ ( f ( {x}_{i} , θ ) , {y}_{i} ) \leq ɛ \}\end{matrix} \qquad ( 1 )$$

where f(⋅,⋅) and ρ(⋅,⋅) represent the model transform and fitting residual metric function, respectively.

### Problem Reformulation

To make the formulation more straight forward, an indicator variable u={0,1}^{N} is introduced. Here, uᵢ=1 means (xᵢ, yᵢ) belongs to the inliers. Equation (1) may be formulated as follows:

$$\begin{matrix}{max}_{θ , u} & {‖ u ‖}_{1} \\ s . t . & {‖ P ‖}_{∞} \leq ɛ , \\ & {P}_{i} = ρ ( f ( {x}_{i} , θ ) , {y}_{i} ) \cdot {u}_{i}\end{matrix} \qquad ( 2 )$$

where Pᵢ represent a robust fitting residual function.

In some embodiments, to establish an efficient algorithm, the maximum residual constraint is relaxed to the mean error restriction. This relaxation has a very clear physical meaning, which is to require the average fitting error in the consensus set to be smaller than the threshold. A solution of the original CSM problem can also be a feasible solution of this relaxed problem. Formally, the relaxed problem is defined as

$$\begin{matrix}{max}_{θ , u} & {‖ u ‖}_{1} \\ s . t . & \frac{{‖ P ‖}_{1}}{{‖ u ‖}_{1}} \leq ɛ , \\ & {P}_{i} = ρ ( f ( {x}_{i} , θ ) , {y}_{i} ) \cdot {u}_{i}\end{matrix} \qquad ( 3 )$$

In some embodiments, considering that the optimal value of equation (3) can only be integer and is possible only in the region [0, N], the decision problem (DP) that is related to equation (3) is defined as:

$$\begin{matrix}Given & {( {x}_{i} , {y}_{i} )}_{i = 1}^{N} do there exist u , θ \\ s . t . & {‖ u ‖}_{1} = k , \\ & {‖ P ‖}_{1} \leq k \cdot ɛ , \\ & {P}_{i} = ρ ( f ( {x}_{i} , θ ) , {y}_{i} ) \cdot {u}_{i}\end{matrix} \qquad ( 4 )$$

where k is the size of the consensus set. If equation (4) can be efficiently solved, then equation (3) can be solved by a one-dimensional searching for k.

### Alternative Fitting Algorithm

In this section, how to solve equation (4) efficiently is disclosed. In some embodiments, k items that satisfy ∥u∥=k are selected automatically, but these items might not satisfy ∥ P∥₁≤k·ε at the same time. Thus, solving equation (4) can be transformed into an optimization problem, which is to find values of θ and u that can minimize ∥P∥₁. Formally, this optimization problem is defined as:

$$\begin{matrix}{max}_{θ , u} & {‖ P ‖}_{1} \\ s . t . & {‖ u ‖}_{1} = k \\ & {P}_{i} = ρ ( f ( {x}_{i} , θ ) {y}_{i} ) \cdot {u}_{i}\end{matrix} \qquad ( 5 )$$

According to the definition of equation (5), the original DP equation (4) is feasible if and only if the optimal value of equation (5) is not larger than k·ε. Obviously, this condition is a sufficient condition. A short verification is provided to show that this condition is also necessary. Here, equation (4) is feasible means that there exist some θ and u such that ∥P∥₁≤k·ε. The optimal value of equation (5) must be equal to or less than k·ε because the optimal solution is not worse than arbitrary solutions.

In some embodiments, observing that if the model parameters θ are fixed, the optimal label variable u is to set the k items that have the smallest fitting error to 1. This operation is extremely efficient because the k-smallest items in an array can be found in O(N) time. If the label variable u is fixed, the optimal θ can be efficiently obtained by a least square approach. Alternatively, a local convergent solution is eventually obtained by updating θ and u until ∥P∥₁ cannot be decreased. These steps in Algorithm 2 are summarized as shown below. To solve equation (3), a sequence of problems in equation (4) that have different consensus set sizes k are solved, and the best one is selected. Algorithm 1 (see below) summarizes the overall process for addressing equation (3). The original consensus maximization problem is identical to equation (2), and equation (3) is the relaxed version of equation (2). In solving each DP except the first one, θ is initialized from the previous result. The initial θ for the first DP is identical to the initialization of Algorithm 1. To demonstrate the robustness, LSQ (least square) is applied over all measurement data as the initialization. In certain real-life applications, users can use some domain knowledge to obtain a better initialization.

Algorithm 1 Alternative Fitting Algorithm for solving (3).

```
Input: S = (xᵢ, yᵢ)ᵢ₌₁^{N}, θᵢₙᵢₜ, ε, δ, τₘᵢₙ
Output: θ;
  1: Initialize: C ← ∞, τ = 1, θ ← θᵢₙᵢₜ
  2: while τ ≥ τₘᵢₙ do
  3: [Isfeasible, θ,C] = CheckFeasible(S, θ, N · τ, ε, C)
  4:  if Isfeasible = true then
  5:  break
  6:  else
  7:  τ = τ − δ
  8:  end if
  9: end while
10: return θ
```

Algorithm 2 Check Feasible Algorithm for solving (5).

| Input: (xᵢ,yᵢ)ᵢ₌₁^{N}, θᵢₙᵢₜ, k, ε, Cᵢₙᵢₜ | |
|---|---|
| Output: Isfeasible, θ, C | |
| 1: | Initialize: Isfeasible ← fasle, \tilde{θ} ← θᵢₙᵢₜ, θ ← θᵢₙᵢₜ, |
| | \tilde{C} ← Cᵢₙᵢₜ, C ← Cᵢₙᵢₜ |
| 2: | while true do |
| 3: | rᵢ ← ρ(f(xᵢ,\tilde{θ}),yᵢ), ∀i ∈ {1,2,... ,N} |
| 4: | $\begin{matrix}{u}_{i} ← \{ \begin{matrix}1 & {r}_{i} \leq k \text{–} th largest item of r \\ 0 & Otherwise\end{matrix} \\ \text{∀} i ∈ \{ 1 \text{,} 2 \text{,} … \text{,} N \}\end{matrix}$ |
| 5: | \tilde{θ} ← ModelFitting((xᵢ,yᵢ)ᵢ₌₁^{N},∀i ∈ {uᵢ = 1}) |
| 6: | Pᵢ ← ρ(f(xᵢ,\tilde{θ}),yᵢ) · uᵢ, ∀i ∈ {1,2,... ,N} |
| 7: | \tilde{C} ← ∥P∥₁ |
| 8: | if \tilde{C} ≤ k · ε then |
| 9: | Isfeasible ← ture |
| 10: | break |
| 11: | else |
| 12: | if \tilde{C} < C then |
| 13: | θ ← \tilde{θ}, C ← \tilde{C} |
| 14: | else |
| 15: | break |
| 16: | end if |
| 17: | end if |
| 18: | end while |
| 19: | return Isfeasible, θ, C |

### Evaluation of Experiments

In some embodiments, the experiments are focused on two types of model fitting problems. The first type of model fitting is hyper-plane estimation, in which the model function is

$$y = {θ}^{T} \cdot ( \begin{matrix}x \\ 1\end{matrix} ) ,$$

where x∈ [symbol] ^{m}, θ∈ [symbol] ^{m+1}, y∈ [symbol] , and the residual metric is

$$ρ = \vert {\tilde{θ}}^{T} \cdot ( \begin{matrix}{x}_{i} \\ 1\end{matrix} ) - {y}_{i} \vert .$$

This problem can be efficiently solved by least squares if no outliers exist. The second type of model fitting is to estimate the homography matrix. More formally, the location of a key point in reference view is defined as

$$x = ( \begin{matrix}u \\ v\end{matrix} ) ,$$

and the corresponding point in the moving view is defined as

$$y = ( \begin{matrix}{u}^{′} \\ {v}^{′}\end{matrix} ) .$$

If these key points are projected from a planar surface in 3D world, then they satisfy

$$λ ( \begin{matrix}y \\ 1\end{matrix} ) = θ \cdot ( \begin{matrix}x \\ 1\end{matrix} ) where \\ λ ∈ ℝ and θ = ( \begin{matrix}{θ}_{11} & {θ}_{12} & {θ}_{13} \\ {θ}_{21} & {θ}_{22} & {θ}_{23} \\ {θ}_{31} & {θ}_{32} & {θ}_{33}\end{matrix} ) . \qquad ( 6 )$$

Although equation (6) appears to be a linear system, it actually belongs to a non-linear transformation, which can be easily verified by writing the expanded formula as

$${u}^{′} = \frac{{θ}_{11} u + {θ}_{12} v + {θ}_{13}}{{θ}_{31} u + {θ}_{32} v + {θ}_{33}} , \\ {v}^{′} = \frac{{θ}_{21} u + {θ}_{22} v + {θ}_{23}}{{θ}_{31} u + {θ}_{32} v + {θ}_{33}} \qquad ( 7 )$$

The homography matrix estimation problem is to replace f(⋅,⋅) and ρ(⋅,⋅) in equation (1) with

$$( \begin{matrix}{y}_{i} \\ 1\end{matrix} ) = θ ( \begin{matrix}{x}_{i} \\ 1\end{matrix} )$$

and |yᵢ−\tilde{y}ᵢ|₂, respectively, where

$$( \begin{matrix}\tilde{{y}_{i}} \\ 1\end{matrix} ) = \tilde{θ} ( \begin{matrix}{x}_{i} \\ 1\end{matrix} )$$

respectively.

In some embodiments, the least square solution is used over all input data to initialize Algorithm 2. The algorithms can be implemented under MATLAB R2017b, and the hardware platform was a laptop computer with Intel Core i7-7700HQ CPU of 2.8 GHz and 32 GB of DDR4 RAM. All experiments can be executed on this platform. For each disclosed result, the internal parameters of Algorithm 1 is set to δ=0.05 and τₘᵢₙ=0.1. All internal parameters listed in H. Le, T. J. Chin, and D. Suter, “An Exact Penalty Method for Locally Convergent Maximum Consensus,” in Proc. IEEE Int. Conf. Comput. Vis. Pattern Recognit., 2017, pp. 379-387, whose contents are incorporated herein by reference, were unchanged. Note that although the main focus is on solving equation (3), the l_{∞}-norm metric (defined in equation (2)) is still used to justify whether a datum can be classified into the consensus set.

### Hyper Plane Regression

In some embodiments, an evaluation is performed on solving the hyper-plane regression problem defined before. Synthetic data in which the inliers follow a small-variance Gaussian distribution is used, and the outliers are uniformly distributed over a large interval. Independent repeated trials are performed under randomly generated model parameters. By accounting for the size of the consensus set, the disclosed method is compared with EP-LSQ (both initialized with LSQ) under two different outlier distributions: U(0,10) and U(0,100).

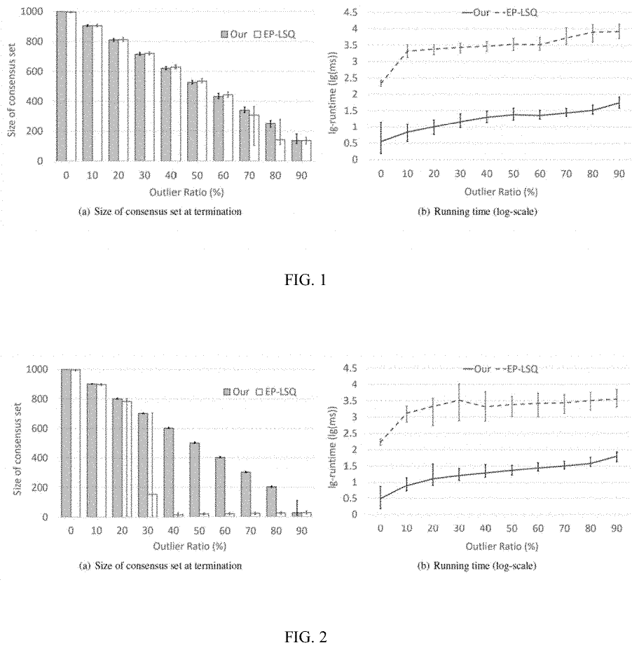

In some embodiments, the evaluation is performed under different outliers-ratio with the total number of data points fixed at 1000. The model dimension is 9, and the inlier threshold is ϵ=0.5. For each outliers-ratio, 100 independent trials are run, and the maximum, average, and minimum size of the inlier set are summarized. The results (e.g., size of the inlier set at each outlier ratio and standard deviation, and running time at each outlier ratio) are shown in FIGS. 1 and 2. As shown in FIG. 2, EP-LSQ breaks down when the outliers-ratio is more than 20%. However, when tuning the distribution of outliers into a small interval, EP-LSQ can yield successful results with only 10% inliers. Compared to EP-LSQ (with Gurobi linear programming solvers), the disclosed method is less sensitive to outliers and more than 100 times faster.

### Homography Estimation

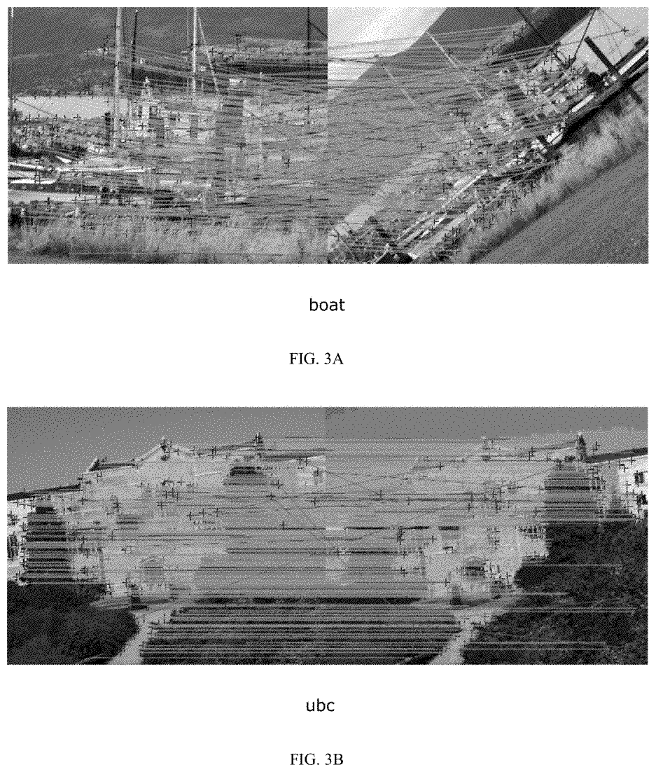

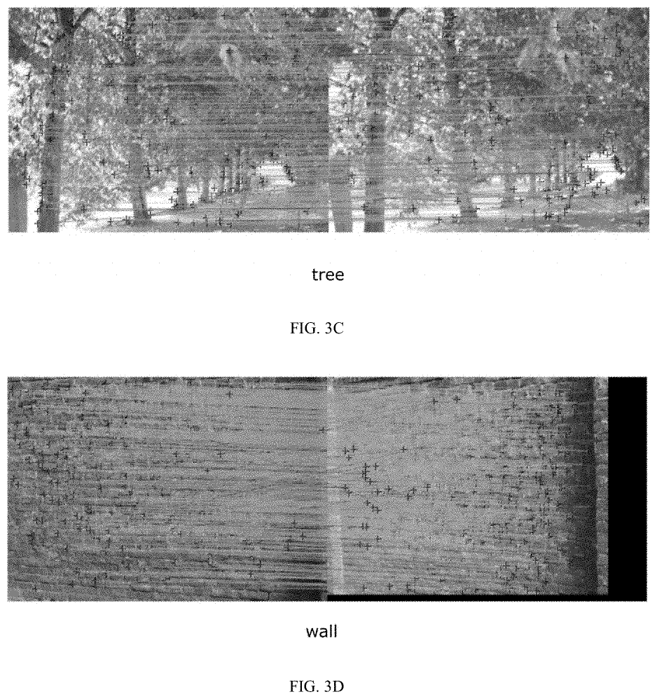

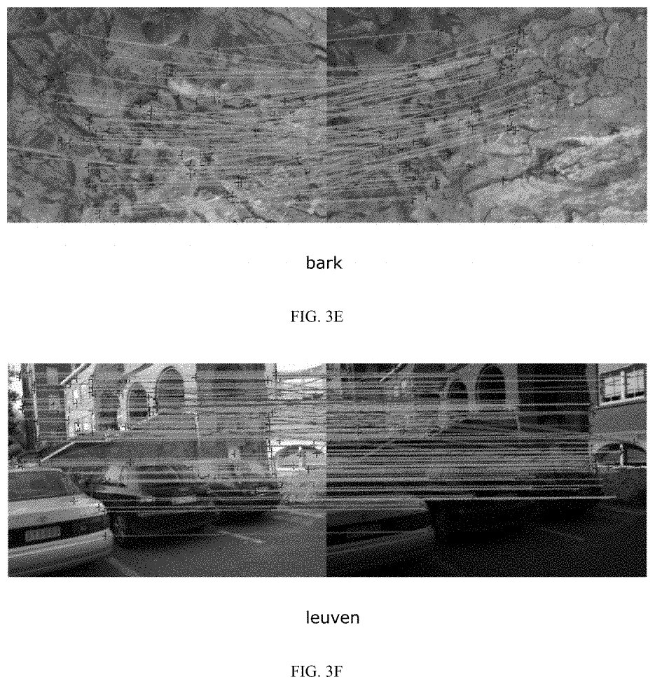

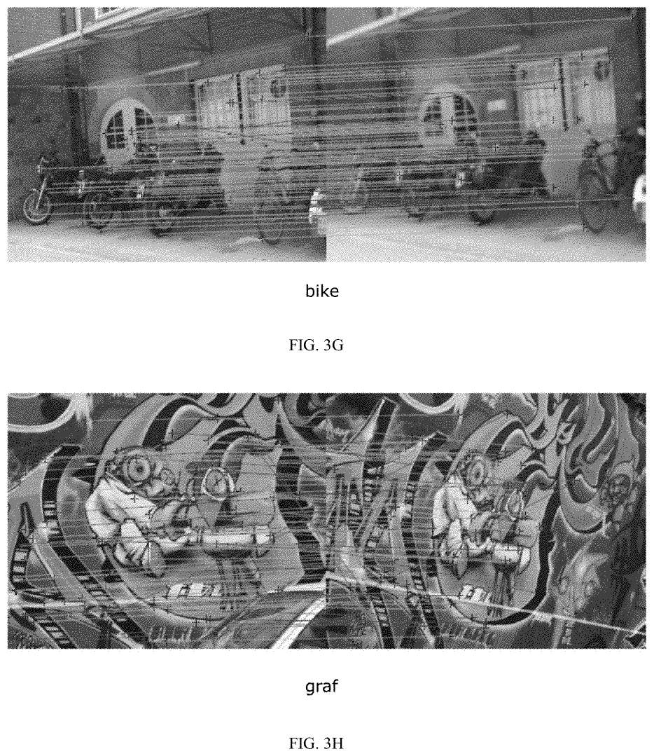

In some embodiments, another evaluation is performed on solving the homography matrix estimation problem defined above. The data used are from the VGG dataset. The MATLAB built-in function detectSURFPoints is first used to extract the image key points. Then, these points are matched according to their SURF features. After obtaining the correspondences, they can treated as input for evaluating the algorithm. In each comparison, LSQ is used to initialize each algorithm, and the inlier threshold ϵ is set to 4 pixels. Because the VGG dataset has 6 images for each scene and provides a reference homography between the first image to five other images, three homographies (the disclosed homography, a reference homography, and an EP-LSQ homography) are compared, and the size of their consensus sets are summarized in TABLE I below. In FIGS. 3A, 3B, 3C, 3D, 3E, 3F, 3G, and 3H, several intuitive examples are provided to illustrate the performance of the disclosed method, where the green lines denote correct matches (inliers) and red lines denote mismatches (outliers). The eight datasets used in TABLE 1 are illustrated in FIGS. 3A, 3B, 3C, 3D, 3E, 3F, 3G, and 3H. Each illustration comprises a left figure and a right figure, where various pairs of points on the figures are labeled. Matched points between the two figures are linked with a green line, and mismatched points between the two figures are linked with a red line. The left figure has a better quality than the right figure. For example, the right figure may be rotated, blurred, darkened, squeezed, lowered in resolution, etc. The figure pairs may be used in various computer vision applications such as AR and VR, and identifying the inliers and outliers are important. The disclosed method has considerable advantages in terms of both robustness (larger returned consensus set) and running time (shorter running time) as shown in TABLE 1.

TABLE 1
THIS TABLE SHOWS THE COMPARISON RESULTS BETWEEN OUR ALGORITHM AND EP-LSQ[ [symbol] ]
ON VGG DATASET. WHERE N AND T MEANS THE SIZE OF RETURNED CONSENSUS SET AND
RUNNING TIME IN MILLISECOND OF EACH ALGORITHM RESPECTIVELY. N_{ref}
MEANS THE NUMBER OF SUPPORTED [symbol] OF [symbol] GRAPHY PROVIDED BY VGG DATASET.

| | | bark | | bikes | | boat | | graf | |
|---|---|---|---|---|---|---|---|---|---|
| | | Our | EPLSQ | Our | EPLSQ | Our | EPLSQ | Our | EPLSQ |
| 1&2 | N | (N_{ref} = 80) | | (N_{ref} = 461) | | (N_{ref} = 567) | | (N_{ref} = 338) | |
| | | 83 | 0 | 461 | 1 | 567 | 1 | 342 | 3 |
| | T | 5.523 | 279.4 | 4.238 | 636.3 | 7.057 | 8645 | 8.004 | 3547 |
| 1&3 | N | (N_{ref} = 45) | | (N_{ref} = 344) | | (N_{ref} = 314) | | (N_{ref} = 66) | |
| | | 63 | 61 | 345 | 2 | 318 | 2 | 69 | 1 |
| | T | 3.583 | 107.7 | 5.406 | 4760 | 7.834 | 3264 | 8.559 | 373.7 |
| 1&4 | N | (N_{ref} = 52) | | (N_{ref} = 190) | | (N_{ref} = 188) | | (N_{ref} = 6) | |
| | | 52 | 52 | 190 | 187 | 193 | 14 | 6 | 0 |
| | T | 5.305 | 127.8 | 3.260 | 1142 | 8.354 | 2349 | 30.58 | 37.53 |
| 1&5 | N | (N_{ref} = 40) | | (N_{ref} = 130) | | (N_{ref} = 122) | | (N_{ref} = 0) | |
| | | 40 | 23 | 129 | 3 | 102 | 2 | 5 | 0 |
| | T | 5.541 | 223.6 | 5.739 | 757.5 | 7.985 | 448.7 | 18.97 | 6.362 |
| 1&6 | N | (N_{ref} = 13) | | (N_{ref} = 83) | | (N_{ref} = 7) | | (N_{ref} = 0) | |
| | | 13 | 0 | 86 | 0 | 0 | 0 | 4 | 0 |
| | T | 10.27 | 126.8 | 8.225 | 338.1 | 55.14 | 101.3 | 64.65 | 99.64 |
| | | [symbol] | | trees | | [symbol] | | wall | |
| | | Our | EPLSQ | Our | EPLSQ | Our | EPLSQ | Our | EPLSQ |
| 1&2 | N | (N_{ref} = 478) | | (N_{ref} = 542) | | (N_{ref} = 1182) | | (N_{ref} = 853) | |
| | | 477 | 473 | 543 | 1 | 1182 | 1179 | 854 | 849 |
| | T | 4.917 | 6588 | 7.101 | 12134 | 4.996 | 33457 | 6.059 | 13730 |
| 1&3 | N | (N_{ref} = 311) | | (N_{ref} = 374) | | (N_{ref} = 1029) | | (N_{ref} = 523) | |
| | | 311 | 1 | 384 | 1 | 1029 | 1026 | 491 | 517 |
| | T | 6.867 | 956.4 | 9.227 | 3030 | 5.638 | 28566 | 5.955 | 3577 |
| 1&4 | N | (N_{ref} = 236) | | (N_{ref} = 159) | | (N_{ref} = 822) | | (N_{ref} = 225) | |
| | | 235 | 0 | 184 | 0 | 822 | 819 | 236 | 3 |
| | T | 6.021 | 1746 | 9.075 | 1016 | 7.135 | 23651 | 11.08 | 1993 |
| 1&5 | N | (N_{ref} = 141) | | (N_{ref} = 67) | | (N_{ref} = 492) | | (N_{ref} = 70) | |
| | | 140 | 0 | 60 | 1 | 492 | 1 | 71 | 1 |
| | T | 6.738 | 203.5 | 8.660 | 324.4 | 7.826 | 6997 | 12.69 | 424.7 |
| 1&6 | N | (N_{ref} = 88) | | (N_{ref} = 26) | | (N_{ref} = 200) | | (N_{ref} = 5) | |
| | | 88 | 2 | 30 | 1 | 203 | 197 | 0 | 1 |
| | T | 8.278 | 461.8 | 15.92 | 159.7 | 9.046 | 2247 | 49.68 | 101.5 |

[symbol]

indicates data missing or illegible when filed

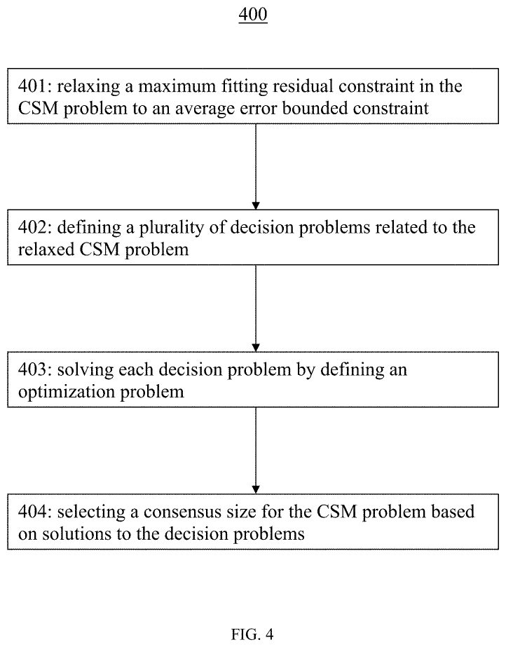

FIG. 4 is an exemplary flowchart for a method 400 of approximately solving a consensus set maximization (“CSM”) problem for a dataset, according to various embodiments of the present disclosure. The exemplary method 400 may be implemented by one or more components of the system (e.g., the processor and the memory) described below. The exemplary method 400 may be implemented by multiple systems similar to the exemplary system. The operations of method 400 presented below are intended to be illustrative. Depending on the implementation, the exemplary method 400 may include additional, fewer, or alternative steps performed in various orders or in parallel.

At block 401, a maximum fitting residual constraint in the CSM problem is relaxed to an average error bounded constraint. At block 402, a plurality of decision problems related to the relaxed CSM problem are defined. At block 403, each decision problem is solved by defining an optimization problem, At block 404, a consensus size for the CSM problem is selected based on solutions to the decision problems.

In some embodiments, the CSM problem comprises determining a maximum size of a consensus set within the dataset supporting a common model having a plurality of model parameters (θ).

In some embodiments, the maximum fitting residual constraint comprises a model fitting residual of each item in the dataset is not larger than an inlier threshold ϵ.

In some embodiments, the average error bounded constraint comprises an average fitting error in the consensus set is not larger than an inlier threshold ϵ.

In some embodiments, each of the decision problems comprises determining an indicator variable (u) so that the average fitting error is no larger than the inlier threshold ϵ times a size of the consensus set (k). Solving each of the decision problems comprises determining an indicator variable (u) so that an optimal value to minimize the L₁-norm of a robust residual function (∥P∥₁) is no larger than the inlier threshold ϵ times the size of the consensus set (k). The method further comprises selecting the maximum value of the sizes of the consensus set (k) of the decision problems as the consensus size for the CSM problem.

In some embodiments, the method is configured for hyper-plane estimation and the common model is defined by a model function

$$y = {θ}^{T} \cdot ( \begin{matrix}x \\ 1\end{matrix} ) ,$$

where x∈ [symbol] ^{m}, θ∈ [symbol] ^{m+1}, y∈ [symbol] , and the residual metric is

$$ρ = \vert {\tilde{θ}}^{T} \cdot ( \begin{matrix}{x}_{i} \\ 1\end{matrix} ) - {y}_{i} \vert .$$

In some embodiments, the method is configured for homography matrix estimation, and the common model is defined by a model function

$$λ ( \begin{matrix}y \\ 1\end{matrix} ) = θ \cdot ( \begin{matrix}x \\ 1\end{matrix} ) ,$$

where the location of a point in a reference view is defined as

$$x = ( \begin{matrix}u \\ v\end{matrix} ) ,$$

the location of a corresponding point in a moving view is defined as

$$y = ( \begin{matrix}{u}^{′} \\ {v}^{′}\end{matrix} ) , λ ∈ ℝ and θ = ( \begin{matrix}{θ}_{11} & {θ}_{12} & {θ}_{13} \\ {θ}_{21} & {θ}_{22} & {θ}_{23} \\ {θ}_{31} & {θ}_{32} & {θ}_{33}\end{matrix} ) .$$

The dataset comprises a VGG (Visual Geometry Group) dataset.

According to various embodiments of the present disclosure, an exemplary system of approximately solving a consensus set maximization (“CSM”) problem for a dataset can comprise at least one computing system (e.g., computer, server, etc.) that includes one or more processors and memory. The memory may be non-transitory and computer-readable. The memory may store instructions that, when executed by the one or more processors, cause the one or more processors to perform various operations described herein. The system may be implemented on or as various computing devices such as mobile phone, tablet, server, computer, wearable device (smart watch), etc. The system may be installed with appropriate software (e.g., data transfer program, etc.) and/or hardware (e.g., wire connections, wireless connections, etc.) to access other devices.

### CONCLUSION

In this disclosure, a fast and deterministic method is disclosed to approximately solve the CSM. It is first formulated as maximizing the l₁-norm over the discrete label variable u. Then, the original maximum fitting residual constraint is relaxed to the average error bounded constraint, which not only simplify the problem but also have an explicit physical meaning. Finally, the relaxed problem is approximately solved by checking the feasibility over its decision problems. Experiments on fitting linear hyper-planes and non-linear homographies illustrate that the disclosed method can efficiently handle large-scale input data and effectively address highly corrupted data (the outliers-ratio can be up to 80%).

In accordance with embodiments of the present disclosure, a fast and determinative method is provided to quickly and correctly estimate model parameters for a dataset containing corrupt data or errors (outliers). This method has wide application in intelligent machine and computer vision, including vision-based motion estimation, 3D reconstruction, and map fusion. The method can be used in robot navigation system software, positioning software in VR/AR system, 3D reconstruction, and map construction software.

The various modules, units, and components described above can be implemented as an Application Specific Integrated Circuit (ASIC); an electronic circuit; a combinational logic circuit; a field programmable gate array (FPGA); a processor (shared, dedicated, or group) that executes code; or other suitable hardware components that provide the described functionality. The processor can be a microprocessor provided by from Intel, or a mainframe computer provided by IBM.

Note that one or more of the functions described above can be performed by software or firmware stored in memory and executed by a processor, or stored in program storage and executed by a processor. The software or firmware can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The various embodiments of the present disclosure are merely preferred embodiments, and are not intended to limit the scope of the present disclosure, which includes any modification, equivalent, or improvement that does not depart from the spirit and principles of the present disclosure.

What is claimed is:

1. A method for approximately solving a consensus set maximization (“CSM”) problem for a dataset, comprising:
relaxing a maximum fitting residual constraint in the CSM problem to an average error bounded constraint;
defining a plurality of decision problems related to the relaxed CSM problem;
solving each decision problem by defining an optimization problem; and
selecting a consensus size for the CSM problem based on solutions to the decision problems.

2. The method of claim 1, wherein the CSM problem comprises determining a maximum size of a consensus set within the dataset supporting a common model having a plurality of model parameters (θ).

3. The method of claim 1, wherein the maximum fitting residual constraint comprises a model fitting residual of each item in the dataset is not larger than an inlier threshold ϵ.

4. The method of claim 1, wherein the average error bounded constraint comprises an average fitting error in the consensus set is not larger than an inlier threshold ϵ.

5. The method of claim 4, wherein each of the decision problems comprises determining an indicator variable (u) so that the average fitting error is no larger than the inlier threshold ϵ times a size of the consensus set (k).

6. The method of claim 5, wherein solving each of the decision problems comprises determining an indicator variable (u) so that an optimal value to minimize the L₁-norm of a robust residual function (∥P∥₁) is no larger than the inlier threshold ϵ times the size of the consensus set (k).

7. The method of claim 6, further comprising selecting the maximum value of the sizes of the consensus set (k) of the decision problems as the consensus size for the CSM problem.

8. The method of claim 1, wherein the method is configured for hyper-plane estimation, and the common model is defined by a model function
$$y = {θ}^{T} \cdot ( \begin{matrix}x \\ 1\end{matrix} ) ,$$
where x∈ [symbol] ^{m}, θ∈ [symbol] ^{m+1}, y∈ [symbol] , and the residual metric is
$$ρ = \vert {\tilde{θ}}^{T} \cdot ( \begin{matrix}{x}_{i} \\ 1\end{matrix} ) - {y}_{i} \vert .$$

9. The method of claim 1, wherein the method is configured for homography matrix estimation, and the common model is defined by a model function
$$λ ( \begin{matrix}y \\ 1\end{matrix} ) = θ \cdot ( \begin{matrix}x \\ 1\end{matrix} ) ,$$
where the location of a point in a reference view is defined as
$$x = ( \begin{matrix}u \\ v\end{matrix} ) ,$$
the location of a corresponding point in a moving view is defined as
$$y = ( \begin{matrix}{u}^{′} \\ {v}^{′}\end{matrix} ) , λ ∈ ℝ and θ = ( \begin{matrix}{θ}_{11} & {θ}_{12} & {θ}_{13} \\ {θ}_{21} & {θ}_{22} & {θ}_{23} \\ {θ}_{31} & {θ}_{32} & {θ}_{33}\end{matrix} ) .$$

10. The method of claim 9, wherein the dataset comprises a VGG (Visual Geometry Group) dataset.

11. A non-transitory computer-readable medium having stored thereon computer-executable instructions, said computer-executable instructions comprising a method for approximately solving a consensus set maximization (“CSM”) problem for a dataset, comprising:
relaxing a maximum fitting residual constraint in the CSM problem to an average error bounded constraint;
defining a plurality of decision problems related to the relaxed CSM problem;
solving each decision problem by defining an optimization problem; and
selecting a consensus size for the CSM problem based on solutions to the decision problems.

12. The computer-readable medium of claim 11, wherein the CSM problem comprises determining a maximum size of a consensus set within the dataset supporting a common model having a plurality of model parameters (θ).

13. The computer-readable medium of claim 11, wherein the maximum fitting residual constraint comprises a model fitting residual of each item in the dataset is not larger than an inlier threshold ϵ.

14. The computer-readable medium of claim 11, wherein the average error bounded constraint comprises an average fitting error in the consensus set is not larger than an inlier threshold ϵ.

15. The computer-readable medium of claim 14, wherein each of the decision problems comprises determining an indicator variable (u) so that the average fitting error is no larger than the inlier threshold ϵ times a size of the consensus set (k).

16. The computer-readable medium of claim 15, wherein solving each of the decision problems comprises determining an indicator variable (u) so that an optimal value to minimize the L₁-norm of a robust residual function (∥P∥₁) is no larger than the inlier threshold ϵ times the size of the consensus set (k).

17. The computer-readable medium of claim 16, wherein the method further comprising selecting the maximum value of the sizes of the consensus set (k) of the decision problems as the consensus size for the CSM problem.

18. The computer-readable medium of claim 11, wherein the method is configured for hyper-plane estimation, and the common model is defined by a model function
$$y = {θ}^{T} \cdot ( \begin{matrix}x \\ 1\end{matrix} ) ,$$
where x∈ [symbol] ^{m}, θ∈ [symbol] ^{m+1}, y∈ [symbol] , and the residual metric is
$$ρ = \vert {\tilde{θ}}^{T} \cdot ( \begin{matrix}{x}_{i} \\ 1\end{matrix} ) - {y}_{i} \vert .$$

19. The computer-readable medium of claim 11, wherein the method is configured for homography matrix estimation, and the common model is defined by a model function
$$λ ( \begin{matrix}y \\ 1\end{matrix} ) = θ \cdot ( \begin{matrix}x \\ 1\end{matrix} ) ,$$
where the location of a point in a reference view is defined as
$$x = ( \begin{matrix}u \\ v\end{matrix} ) ,$$
the location of a corresponding point in a moving view is defined as
$$y = ( \begin{matrix}{u}^{′} \\ {v}^{′}\end{matrix} ) , λ ∈ ℝ and θ = ( \begin{matrix}{θ}_{11} & {θ}_{12} & {θ}_{13} \\ {θ}_{21} & {θ}_{22} & {θ}_{23} \\ {θ}_{31} & {θ}_{32} & {θ}_{33}\end{matrix} ) .$$

20. The computer-readable medium of claim 19, wherein the dataset comprises a VGG (Visual Geometry Group) dataset.
